(19) United States
(12) Patent Application Publication
(10) Pub. No.: US 2002/0167514 A1
(43) Pub. Date: Nov. 14, 2002

(54) Polygon generating apparatus and drawing system

(75) Inventor: Takahiro Saito, Yokohama-Shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Tokyo (JP)

(21) Appl. No.: 10/108,464

(22) Filed: Mar. 29, 2002

(30) Foreign Application Priority Data
Mar. 30, 2001 (JP) 2001-101674
Mar. 27, 2002 (JP) 2002-089392

(51) Int. Cl. G06T 17/00

(52) U.S. Cl. 345/420

(57) ABSTRACT

A polygon data generating apparatus, comprising: an initial connection data generator configured to generate connection data relating to connection information of vertices, sides and faces, based on vertex data of the inputted polygon; a new connection data generator configured to generate new connection data based on said connection data; a new vertex data generator configured to generate new vertex data based on said vertex data and said connection data; a data combining part configured to combine said new connection data relating to the same vertex; a connection data storing part configured to store the connection data generated by said initial connection data generator and said new connection data generator, and the connection data combined by said data combining part; and a vertex data storing part configured to store the inputted vertex data and the vertex data generated by said new vertex data generator, wherein said new connection data generator repeatedly generates said new connection data based on the connection data stored in said connection data storing part; and said new vertex data storing part repeatedly generates said new vertex data based on the connection data stored in said connection data storing part and the vertex data stored in said vertex data storing part.

### CROSS REFERENCE TO RELATED APPLICATIONS

This application is based upon and claims the benefit of priority from the prior Japanese Patent Applications No. 2001-101674, filed on Mar. 30, 2001, the entire contents of which are incorporated herein by reference.

### BACKGROUND OF THE INVENTION

1. Field of the Invention

The present invention relates to a polygon data generating apparatus and a drawing system for generating polygon data for drawing 3D-objects as a collection of polygons.

2. Related Background Art

A CPU and a graphic control chip perform processings collectively in order to realize 3D-graphics. The 3D-objects are generally drawn as a collection of the polygons. The objects have to be divided into a lot of polygons to display the objects of which curved surface is smooth.

However, when the objects are divided into a lot of polygons, the amount of data transferred between the CPU and the GPU increases. Because of this, the smoothness of the curved surface is limited by a bus band width between the CPU and the GPU.

On the other hand, a subdivision surface processing has been proposed. In the subdivision surface processing, the polygons are repeatedly divided into small pieces in order to smooth the curved surface.

When the subdivision surface processing is implemented by software, the CPU has to execute a complicated and a large amount of list processing. Because of this, there is a problem in which the load of the CPU is large and a processing performance of the CPU is not improved.

### SUMMARY OF THE INVENTION

A polygon data generating apparatus according to an embodiment of the present invention, comprising:

an initial connection data generator configured to generate connection data relating to connection information of vertices, sides and faces, based on vertex data of the inputted polygon;

a new connection data generator configured to generate new connection data based on said connection data;

a new vertex data generator configured to generate new vertex data based on said vertex data and said connection data;

a data combining part configured to combine said new connection data relating to the same vertex;

a connection data storing part configured to store the connection data generated by said initial connection data generator and said new connection data generator, and the connection data combined by said data combining part; and

a vertex data storing part configured to store the inputted vertex data and the vertex data generated by said new vertex data generator,

wherein said new connection data generator repeatedly generates said new connection data based on the connection data stored in said connection data storing part; and

said new vertex data generator repeatedly generates said new vertex data based on the connection data stored in said connection data storing part and the vertex data stored in said vertex data storing part.

### BRIEF DESCRIPTION OF THE DRAWINGS

FIG. 1 is a diagram of an embodiment of a polygon data generating system according to the present invention.

FIG. 2 is a flowchart showing the entire processing operation of the polygon data generating apparatus according to the present embodiment.

FIG. 3 is a diagram showing an example of the polygon.

FIG. 4A-4C is a diagram showing an example of connection data.

FIG. 5 is a flowchart showing a processing operation of the initial connection data generator.

FIG. 6 is a diagram showing an example of the polygon.

FIG. 7 is a diagram showing connection information of v1 in FIG. 6.

FIG. 8 is a diagram showing connection information of v0 in FIG. 6.

FIG. 9 is a diagram showing connection information of v2 in FIG. 6.

FIG. 10A-10B are diagrams in which new vertex is added to the polygon of FIG. 6.

FIG. 11 is a diagram showing connection information of v1 in FIG. 10A.

FIG. 12A-12B are diagrams showing connection information of v2 in FIG. 10A-10B.

FIG. 13 is a diagram showing connection information of v3 in FIG. 10A.

FIG. 14 is a diagram showing an example of the polygon.

FIG. 15 is a diagram showing connection information of v3 in FIG. 14.

FIG. 16A-16B are diagrams showing connection information of v5 and v7 in FIG. 14.

FIG. 17 is a diagram showing an example of the polygon.

FIG. 18 is a diagram showing connection information of v3 in FIG. 17.

FIG. 19A-19B are diagrams showing connection information of v5 and v7 in FIG. 17.

FIG. 20 is a diagram showing an example of the polygon.

FIG. 21A-21B are diagrams showing connection information of v3 in FIG. 20.

FIG. 22 is a flowchart showing a processing procedure of catmull-clark method.

FIG. 23 is a diagram showing an example of the polygon.

FIG. 24 is a diagram showing a table configuration of the second vertex data storing part.

FIG. 25A-25B are diagrams for explaining the side point.

FIG. 26A-26D are diagrams for explaining the face point.

FIG. 27 is a diagram showing an embodiment of a drawing system having the polygon data generating system according to the present embodiment.

FIG. 28 is a layout diagram of an LSI for integrating the GPU 12 of FIG. 27 as one chip.

FIG. 29A-29B are diagrams showing an example of the polygon.

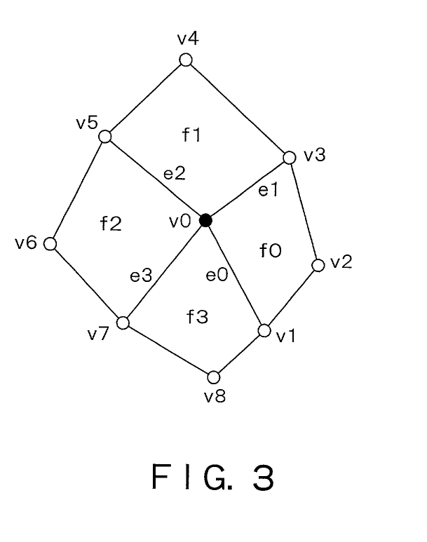

FIG. 3OA-30B are diagrams showing an example of the polygon.

### DESCRIPTION OF THE PREFERRED EMBODIMENTS

Hereinafter, an embodiment of a polygon data generating apparatus and a drawing system according to the present invention will be more specifically described with reference to drawings.

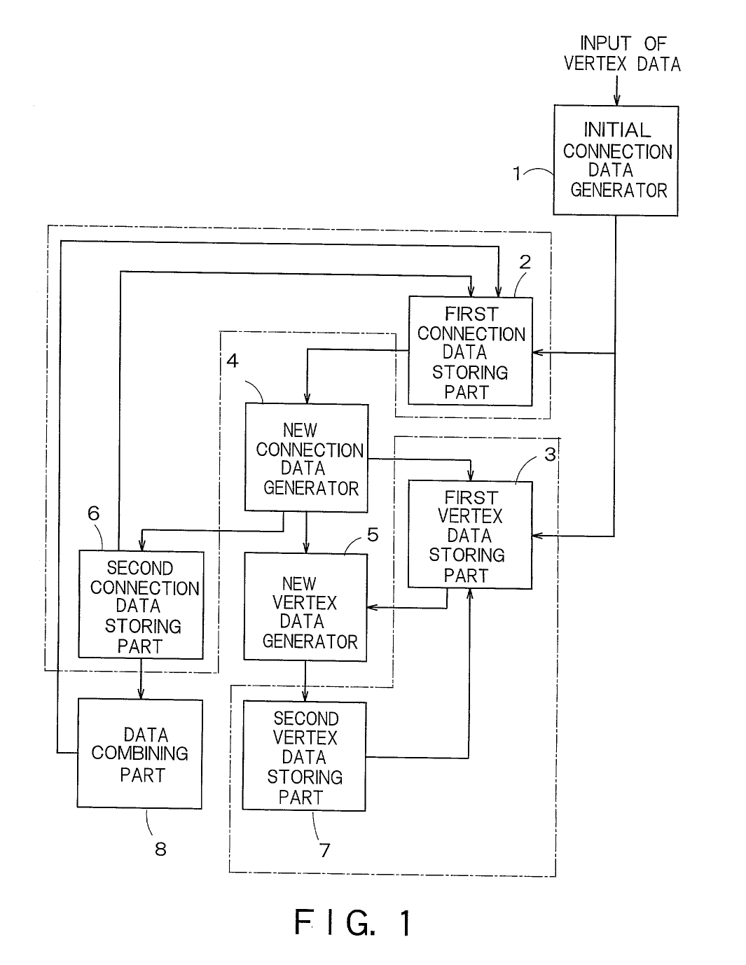

FIG. 1 is a block diagram of an embodiment of a polygon data generating system according to the present invention. In the polygon data generating apparatus of FIG. 1, vertex data is inputted clockwise or counterclockwise in sequence. Hereinafter, although an example in which the vertex data is inputted counterclockwise will be described, the same processings are performed even in the case where the vertex data is inputted clockwise.

The polygon data generating apparatus of FIG. 1 has an initial connection data generator 1 for generating after-mentioned connection data based on the vertex data of the inputted polygon, a first connection data storing part 2 for storing the generated connection data, a first vertex data storing part 3 for storing the inputted vertex data, a new connection data generator 4 for generating new connection data by performing after-mentioned subdivision surface processing, a new vertex data generator 5 for generating new vertex data based on the original connection data, a second connection data storing part 6 for storing the generated new connection data, a second vertex data storing part 7 for storing the generated new vertex data, and a data combining part 8 for combining a plurality of connection data relating to the same vertex.

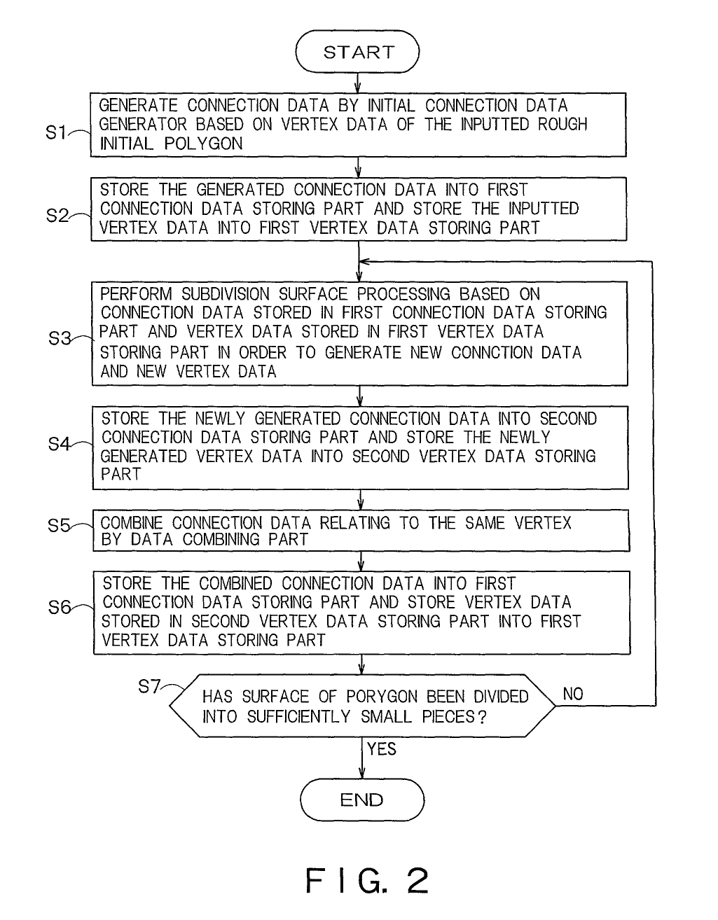

FIG. 2 is a flowchart showing the entire processing operation of the polygon data generating apparatus according to the present embodiment.

First of all, the initial connection data generator 1 generates the connection data based on the vertex data of the inputted rough initial polygon (step S1). The generated connection data is stored in the first connection data storing part 2, and the inputted vertex data is stored in the first vertex data storing part 3 (step S2).

Subsequently, the new vertex data generator 4 and the new vertex data generator 5 generate new connection data and new vertex data, respectively, by performing after-mentioned subdivision surface processing based on the connection data stored in the first connection data storing part 2 and the vertex data stored in the first vertex data storing part 3 (step S3). The newly generated connection data is stored in the second connection data storing part 6, and the newly generated vertex data is stored in the second vertex data storing part 7 (step S4).

Subsequently, the data combining part 8 combines all the connection data relating to the same vertex (step S5). The combined connection data is stored in the first connection data storing part 2, and the vertex data stored in the second vertex data storing part 7 is stored in the first vertex data storing part 3 (step S6).

The above-mentioned processings of step S3-S6 are repeatedly performed until when the curved surfaces of the polygon are divided into sufficiently small pieces (step S7).

As a more specified example, the subdivision surface processing for the polygon of FIG. 3 will be described hereinafter. Although FIG. 3 shows an example in which each surface of the polygon is a quadrangle, the shape of the surface may be triangular shape.

In the polygon data generating apparatus of FIG. 1, the vertex data of FIG. 3 is inputted counterclockwise in sequence. The initial connection data generator 1 generates the connection data by allocating to the vertices, the sides and the faces of the polygon, inherent and continuous numerals as shown in FIG. 3. In FIG. 3, the numerals of the vertices are expressed as v1-v8, the numerals of the sides as e0-e3, and the numerals of the faces as f0-f3.

The vertex data inputted in the initial connection data generator 1 is composed of a vertex coordinate, a normal line vector of the vertex, a texel coordinate of the vertex and so on. Here, the normal line vector of the vertex shows a normal line vector of a minute plane including the vertex among curved surfaces formed of the vertex and the neighborhood vertex. The texel coordinate of the vertex shows a coordinate location in the case of performing texture mapping.

The connection data generated by the initial connection data generator 1 is composed of the number of the sides including the vertices, the number of the faces including the vertices, an inherent number of the sides including the vertices and an inherent number of the other end of the side, an inherent number of the faces including the vertices and an inherent number of the vertex on a diagonal line the face or an inherent number of the vertex neighbor by sandwiching the other vertex and so on.

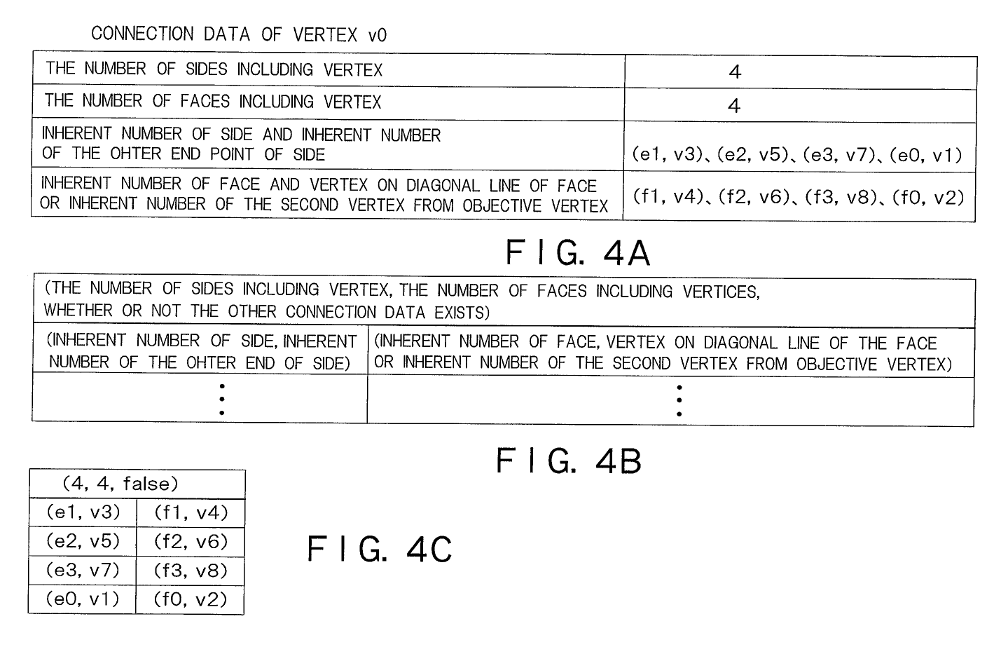

In this specification, the vertex is expresses as “v”, the side as “e”, and the face as “f”. For example, when the vertex data relating to the vertex v0 of the polygon of FIG. 3 is inputted in the initial connection data generator 1, the connection data such as shown in FIG. 4A is generated. The number of the sides including the vertices is “4”, the number of the faces including the vertices is “4”, inherent number of the sides including the vertices and inherent numbers of the other ends of the sides are (e1, v3)(e2, v5)(e3, v7)(e0, v1), inherent numbers of the faces including the vertices and inherent numbers of the vertices on the diagonal line of the face or inherent numbers of the vertex neighbor by sandwiching the other vertex are (f1, v4) (f2, v6) (f3, v8)(f0, v2).

Hereinafter, as a simplified model, the connection data is expressed by (the number of sides including vertices, the number of faces including vertices, an identifier showing whether or not the other connection data exists), (an inherent number of the side, an inherent number of the other end of the side), and (an inherent number of the face, the vertex on diagonal of the face or an inherent number of the second vertex from the objective).

As the identifier showing whether or not the other connection data exists, there are “false” showing that the other connection data does not exist and “true” showing that the other connection data exists.

For example, if FIG. 4A is expressed by a form of FIG. 4B, FIG. 4C is obtained.

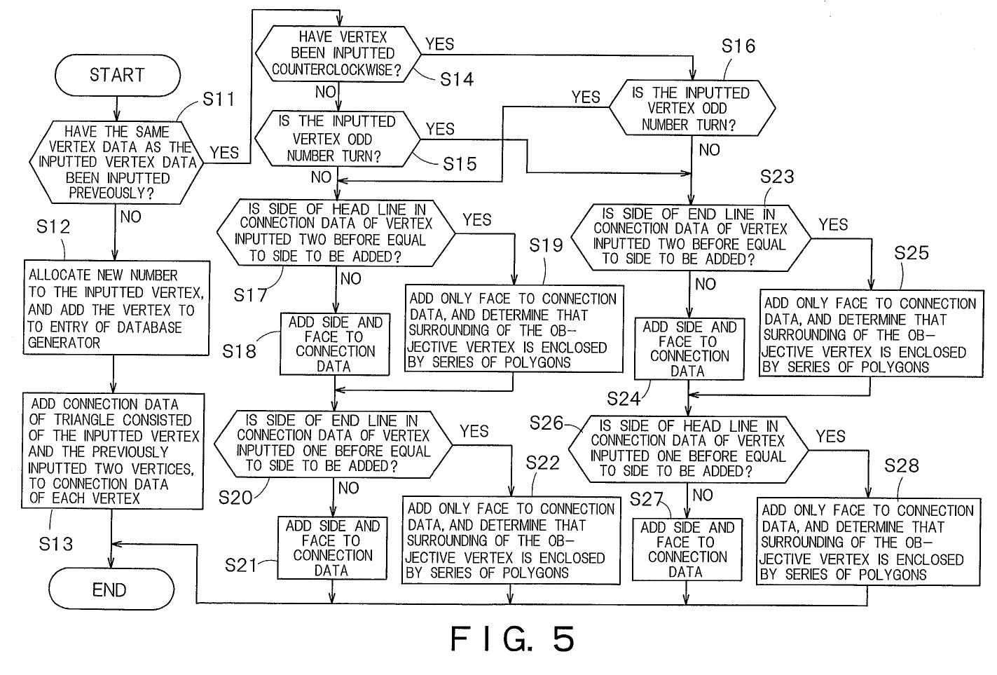

FIG. 5 is a flowchart showing a processing operation of the initial connection data generator 1, and shows the processing operation in the case where the vertex data of the triangle is inputted. First of all, whether or not the same vertex data as the inputted vertex data was inputted before is determined (step S11). Here, the first connecting data generator 1 searches for the first vertex data storing part 3, and checks whether or not the same vertex data exists.

As a result, if the same vertex data is not stored in the first vertex data storing part 3, a new numeral is attached to the vertex and the vertex is added to an entry of the initial connection data generator 1. Here, the addition of the entry means a registration of a new connection data.

On the other hand, if the same vertex data is already stored in the first vertex data storing part 3, the corresponding connection data is read out from the first connection data storing part 2.

Subsequently, connection information of the triangle composed of two vertices of the newly inputted vertex and the previously inputted vertex are added to the connection data of each vertex (step S13).

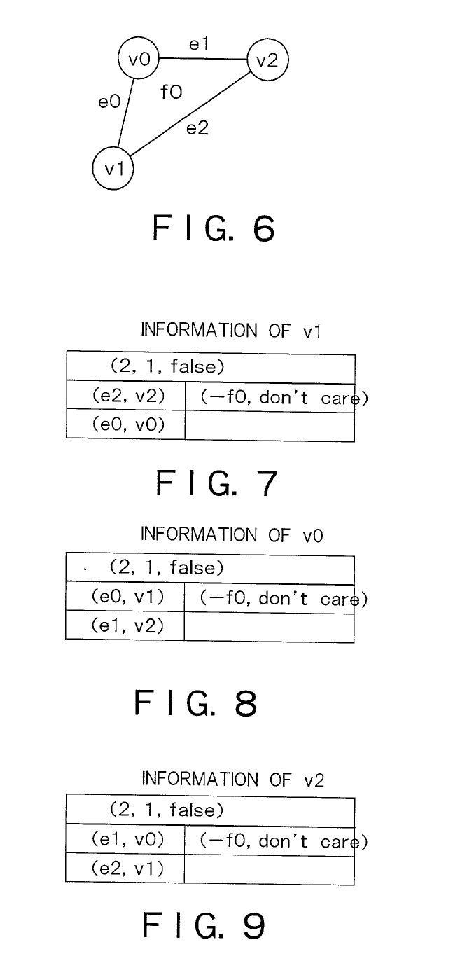

For example, as shown in FIG. 6, it is assumed that the vertices v0 and v1 were already inputted and the vertex data of the vertex v2 is newly inputted. In FIG. 6, the inherent numbers of the vertices are v0, v1 and v2, the inherent numbers of the sides are e0, e1 and e2, and the inherent number of the face is f0.

In this case, the connection information for the vertex v2 is added to the connection data of the vertices v0 and v1. At this time, if assumed that the vertex v2 is data inputted at odd turn, connection information (e2, v2)(−f0, don't care) is added just before the side information (e0,v0) registered just before in the connection data of the vertex inputted one before, i.e., the vertex v1 inputted at even number turn. Furthermore, the connection information (e1, v2) for the vertex v2 is added to the connection data of the vertex inputted two before, that is, the vertex v0 inputted at odd number turn. In this case, the connection information (e1, v2) is added just after the side information (e0, v1)(−f0, don't care) registered just before, as shown in FIG. 8. on the other hand, the connection data of the newly added vertex v2 is shown in FIG. 9.

In FIGS. 7-9, symbols before the face numerals show whether the faces are the triangle or the quadrangle. For example, the triangle is expressed as minus symbol, and the quadrangle is expressed as plus symbol. The “don't care” means that there is no vertex on the opposite corner.

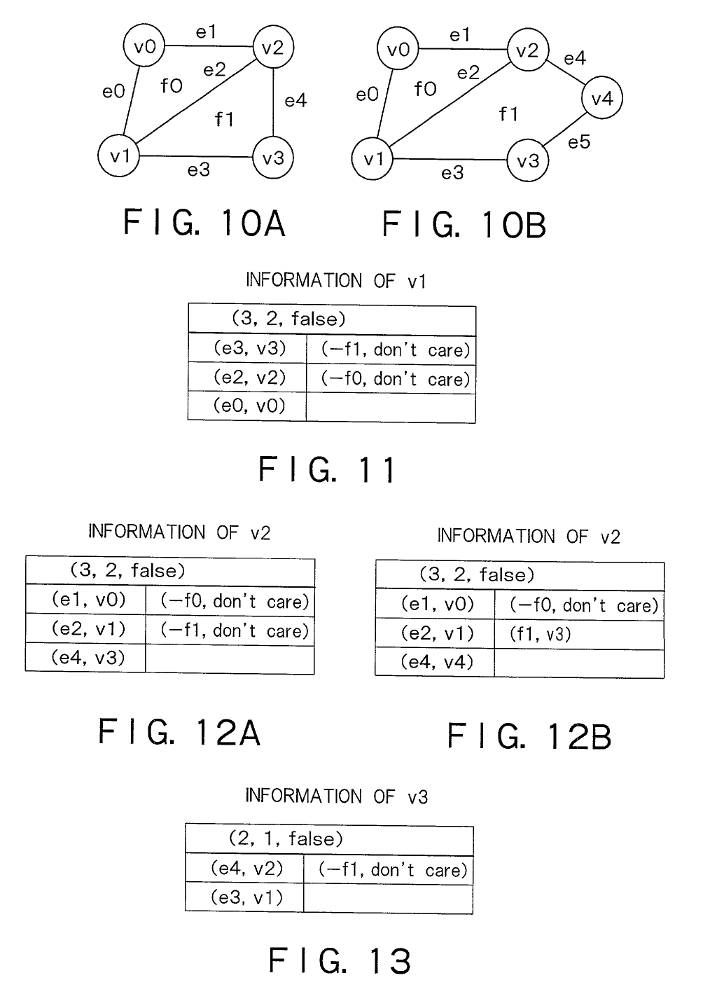

Afterward, as shown in FIG. 10A, if assumed that the vertex data of the vertex v3 is inputted newly, the connection information to the vertex v3 is added to a head of the connection data of the vertex v1, as shown in FIG. 11. The connection information for the vertex v3 is added to the end of the connection data of the vertex v2, as shown in FIG. 12A, and the connection data of the vertex v3 is shown in FIG. 13.

For example, as shown in FIG. 10B, if assumed that the vertex v4 exists besides the vertex v3, the connection data of the vertex v2 in this case is shown in FIG. 12B. In this case, because the vertex v3 exists on the diagonal line, the connection data becomes (f1, v3) instead of “don't care”.

The processing operation of the initial connection data generator 1 will be described again based on FIG. 5. In the above-mentioned step S1 of FIG. 5, if determined that the vertex data relating to the same vertex is inputted, whether or not the vertex data is input counterclockwise is determined( step S14). If the vertex data is not inputted counterclockwise, it is determined whether or not the vertex data is odd number turn (step S15). If the vertex data is inputted counterclockwise, it is determined whether or not the vertex data is odd number turn (step S16).

If determined not to be odd number turn in step S15, or if determined to be odd number turn in step S16, it is determined whether or not the side corresponding to the head line in the connection data of the vertex inputted two before is equal to the side to be added (step S17).

If determined that both sides are equal to each other, the side information and the face information are added to the connection data (step S18). If determined that both sides are equal to each other, only the face information is added to the connection data, and it is determined that the surrounding of the objective vertex is enclosed by the series of polygons (step S19).

When the processings of step S18 and S19 is finished, it is determined whether or not the side of the last line in the connection data of the vertex inputted one before is equal to the side to be added (step S20).

When determined that both sides are not equal to each other, the side information and the face information are added to the connection data (step S21). When determined to be equal, only the face information is added to the connection data, and it is determined that the surrounding of the objective vertex is enclosed (step S22). In this case, because any more new information is not added to the connection data, the connection data corresponding to the vertex is deleted from the entries of the initial connection data generator 1.

On the other hand, if it is determined to be odd number turn in step S15, or it is determined not to be odd number turn in step S16, it is determined whether or not the side of the last line in the connection data of the vertices inputted two before is equal to the side to be added (step S23).

If determined not to be equal, the side information and the face information are added to the connection data (step S24). If determined to be equal, only the face information is added to the connection data, and it is determined that the surrounding of the objective vertex is enclosed by series of polygons (step S25).

The processings of step S24 and S25 are finished, it is determined whether or not the side of the head line in the connection data of the vertex inputted one before is equal to the side to be added (step S26).

If determined not to be equal, the side information and the face information are added to the connection data (step S27). If determined to be equal, only the face information is added to the connection data, and the surrounding of the objective vertex is enclosed by series of polygons (step S28).

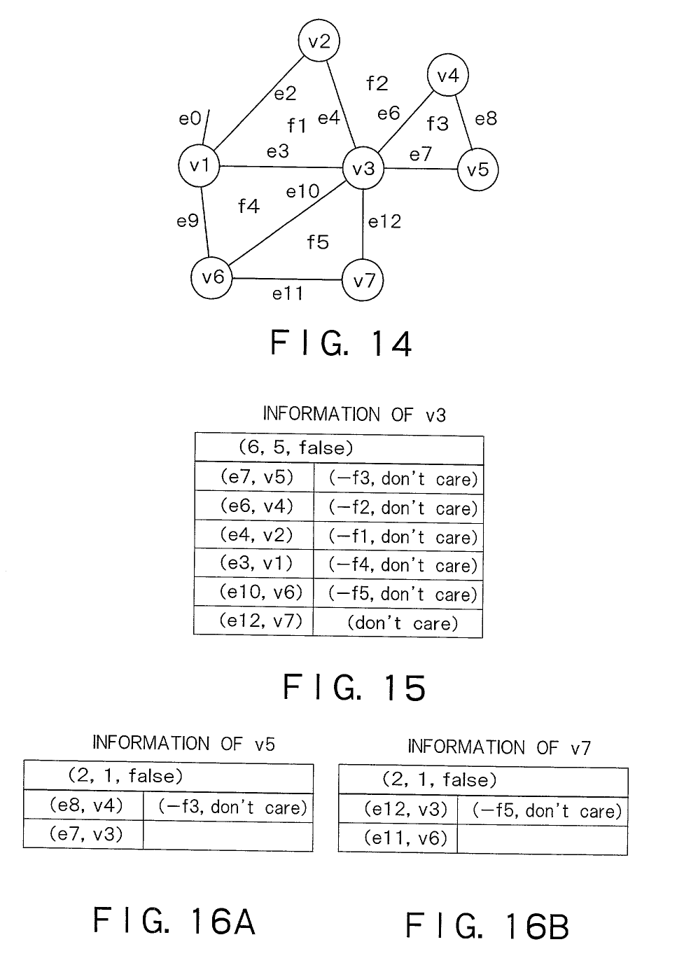

Next, an example in which the initial connection data generator 1 generates the connection data of the polygon of FIG. 14 will be described hereinafter.

For example, as shown in FIG. 14, it is assumed that the vertex data of the vertices v1-v7 are already inputted, the connection data of the vertex v3 is expressed by FIG. 15 at this time, and the connection data of the vertices v5 and v7 are expressed by FIG. 16A and FIG. 16B, respectively.

Furthermore, among the already inputted vertex data, the vertex data of the vertex v3 is inputted two before, the vertex data of the vertex v7 is inputted one before, and then the vertex data of the vertex v5 is inputted.

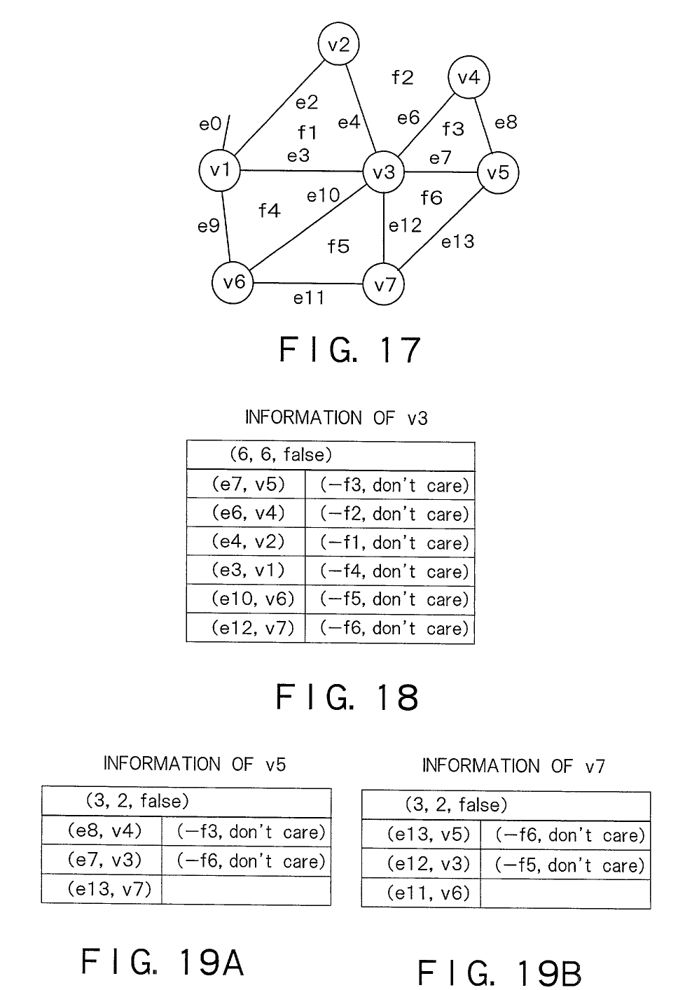

In this case, as shown in FIG. 17, information relating to the side e13 and the face f6 are added to the connection data of the vertices v3 and v7, respectively. More specifically, because the side e7 consisted of the vertices v3 and v5 already exists, only the information of the face f6 is added to the connection data of the vertex v3, as shown in FIG. 18, and the information of the side e13 and the face f6 are added to the respective connection data of the vertices v5 and v7, as shown in FIG. 19A and FIG. 19B.

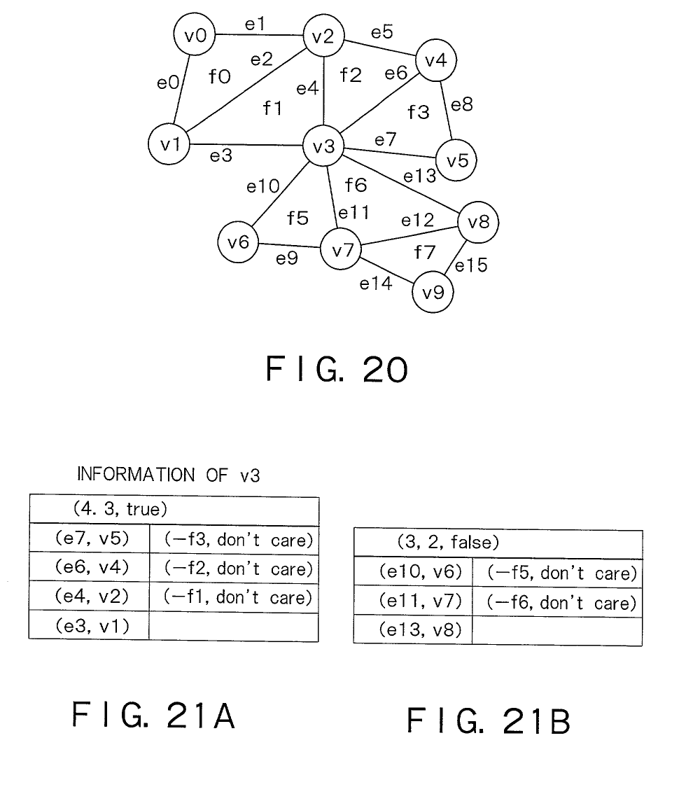

Furthermore, depending on the shape of the polygon, there is a case where the connection data is divided into a plurality of pieces, as shown in FIG. 20. In FIG. 20, with regard to the vertex v3, the connection data shown in FIG. 21A consisted of the vertices v0, v1, v2, v4 and v5, and the connection data shown in FIG. 21B consisted of the vertices v6, v7, v8 and v9 are generated. When the other multiple connection data exists with regard to the same vertex, the “true” identifier is registered to the connection data as shown in FIG. 21A.

When all the connection data is generated by the initial connection data generator 1 based on the above-mentioned procedure, the new connection data generator 4, the new vertex data generator 5 and the data combining part 8 performs the subdivision surface processing based on the connection data stored in the first connection data storing part 2 and the vertex data stored in the first vertex data storing part 3.

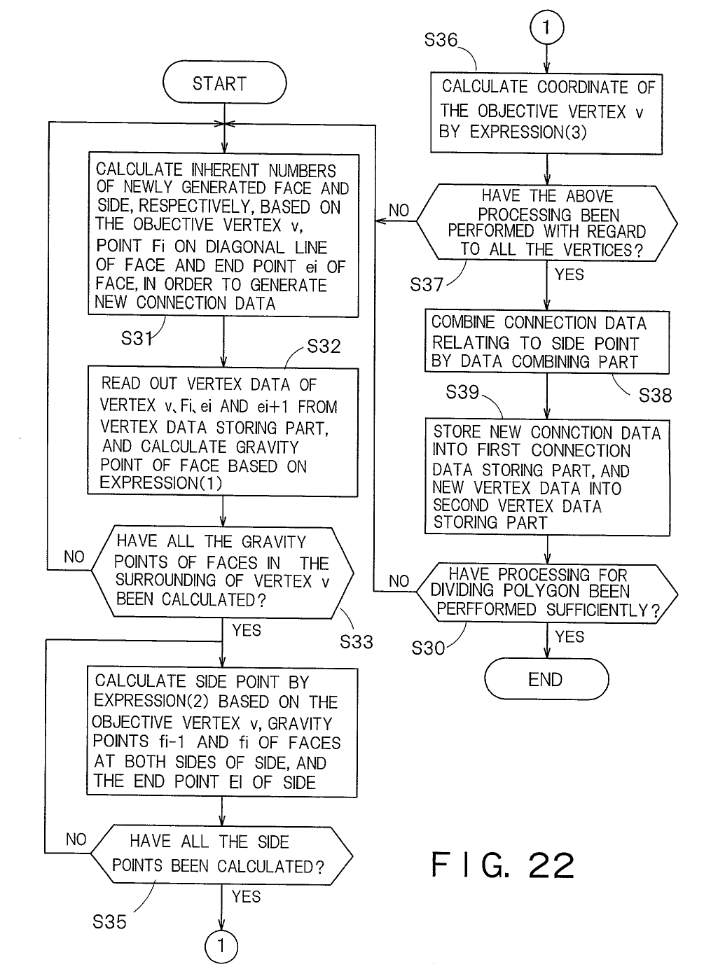

FIG. 22 is a flowchart showing a processing procedure of catmull-clark method, which is one method of the subdivision surface processing. The flowchart describes the processing procedure of step S3-S6 of FIG. 2 in detail.

First of all, the new connection data generator 4 calculates the inherent number of the newly generated face and the inherent number of the side based on the objective vertex v, the point Fi on the diagonal line of the face in which the vertex v exists, and the inherent number of the side, in order to generate the new connection data (step S31).

Subsequently, the new vertex data generator 5 calculates a gravity point of the face by an expression (1) (step S32). Hereinafter, the gravity point is called as a face point.

$${\vec{f}}_{i} = \frac{\vec{v} + {\vec{F}}_{i} + {\vec{e}}_{i} + {\vec{e}}_{i + 1}}{4} \qquad ( 1 )$$

The new vertex data generator 5 repeats the processings of step S32 until when all the face points in the surrounding of the vertex v are calculated (step S33).

After the calculation of the face points is finished, the new vertex data generator 5 calculates a side point by an expression (2) based on the objective vertex v, gravity points fi-1 and fi the faces at both sides of the side, and the end point ei of the side (step S34).

$$e {\vec{p}}_{i} = \frac{{\vec{f}}_{i - 1} + {\vec{f}}_{i} + \vec{v} + {\vec{e}}_{i}}{4} \qquad ( 2 )$$

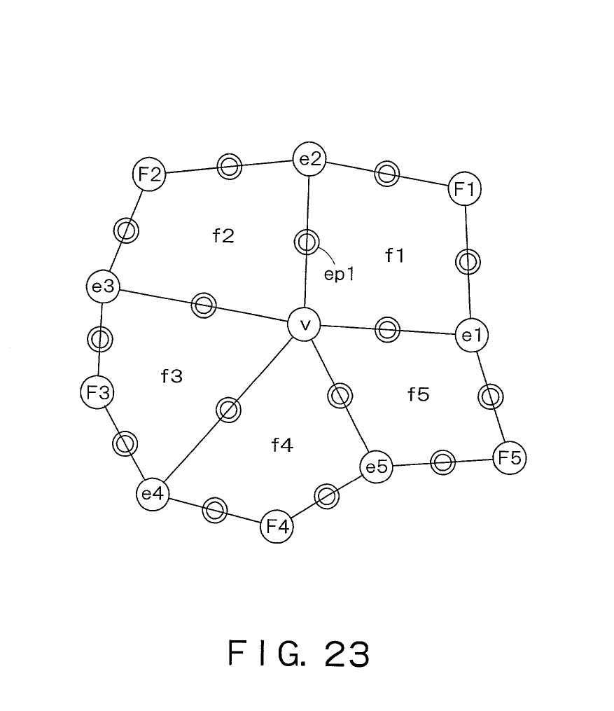

Here, the side point expresses a vertex for dividing the side. For example, the side point ep1 of FIG. 23 corresponds to the gravity point of the face enclosed by both ends points v of the side to be divided, the end point e2, the gravity point of the face f1 and the gravity point of the face f2. The generated face point forms a new face with the original vertex and the gravity point of the peripheral face.

The new vertex data generator 5 repeatedly performs the processing of step S34 until when all the side points corresponding to the vertex v are calculated (step S35).

Subsequently, the new vertex data generator 5 moves the coordinate of the original vertex by an expression (3) (step S36).

$${\vec{v}}^{′} = \frac{\frac{{\sum }_{i = 1}^{n} {\vec{f}}_{i} + {\sum }_{i = 1}^{m} ( {\vec{e}}_{i} + \vec{v} )}{m} + ( m - 3 ) \vec{v}}{m} \qquad ( 3 )$$

The new vertex data generator 5 performs the processings of the above-mentioned steps S31-S36 with regard to all of the original vertices, and calculates the above-mentioned face points and side points by each vertex (step S37).

Subsequently, the data combining part 8 combines the new connection data corresponding to the face points and the side points generated by step S31-S37 (step S38). That is, the data combining part 8 performs the processings for combining the connection data corresponding to the same face points and side points.

The new connection data after the combination is stored in the first connection data storing part 2, and the new vertex data is stored in the first vertex data storing part 3 (step S39).

The above-mentioned processings are repeatedly performed by each of the newly generated face points and side points (step S40). Therefore, it is possible to divide the initial polygon into sufficiently small pieces.

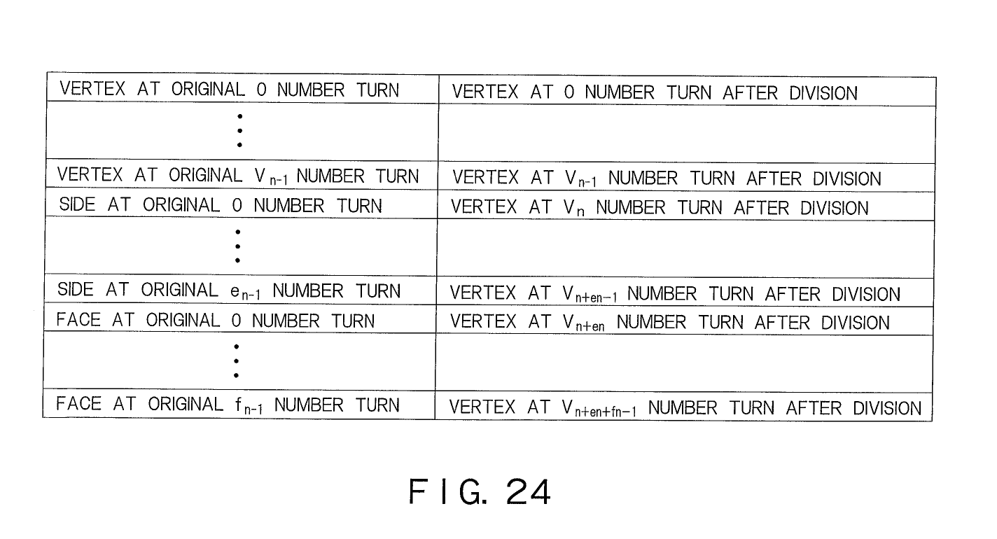

FIG. 24 is a diagram showing a table configuration of the second vertex data storing part 7 for storing the face points and the side points generated by the new vertex data storing part 5. As shown in FIG. 24, the second vertex data storing part 7 stores coordinate data 0−vn−1 after changing the coordinate of the vertex of the initial polygon by the calculation of the expression (3), coordinate data vn−vn+en−1 of the side points, and coordinate data vn+en−vn+enfn−1 in sequence. The coordinate data 0−(vn−1) is corresponded to the vertices 0−vn−1 of the original polygons, the coordinate data vn−vn+en−1 is corresponded to the sides 0−(en−1) of the original polygon, and the coordinate data vn+en−vn+en+fn−1 is corresponded to the faces 0−(fn−1) of the original polygon.

When the subdivision surface processing showing in FIG. 22 are performed, the vertices, the sides and the faces are generated newly. In order to specify these newly generated vertices, sides and faces, the present embodiment allocates inherent numbers to the respective vertices, sides and faces.

With regard to the vertices, a serial number is allocated to each vertex, as shown in FIG. 24.

With regard to the sides, the original side number and numbers obtained by adding the total numbers of the original sides to the respective original side numbers are allocated to the sides shown in FIG. 25B generated by dividing the original side shown in FIG. 25A into two. For example, if it is assumed that the original side number is e0, and the total number of the original sides is en, the side numbers generated by dividing this side into two are e0 and (e0+en).

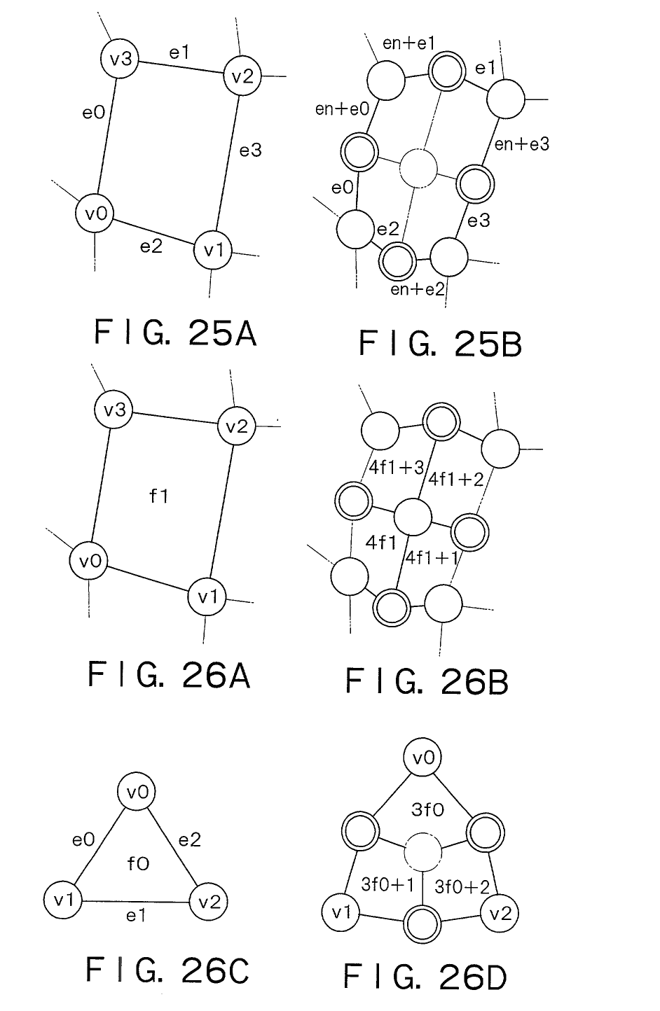

When the face is quadrangle as shown in FIG. 26A, 4-fold, 4-fold+1, 4-fold+2 and 4-fold+3 numbers of the original face numbers are allocated counterclockwise to the faces generated in the surrounding of the face points showing the vertices generated in the face, as shown in FIG. 26B. When the face is triangle as shown in FIG. 26C, 3-fold, 3-fold+1 and 3-fold+2 numbers of the original face numbers are allocated counterclockwise as shown in FIG. 26D. These numbers are also used for numbers of the respective sides.

As mentioned above, according to the present embodiment, the processing for generating independent connection data by each vertex based on the inputted small number of vertex data is performed, and then the subdivision surface processing are repeatedly performed to generate new vertex data and connection data. Because of this, it is possible to draw the polygon having smooth curved surface with the inputted small number of vertex data, thereby drawing at higher speed than the conventional apparatus.

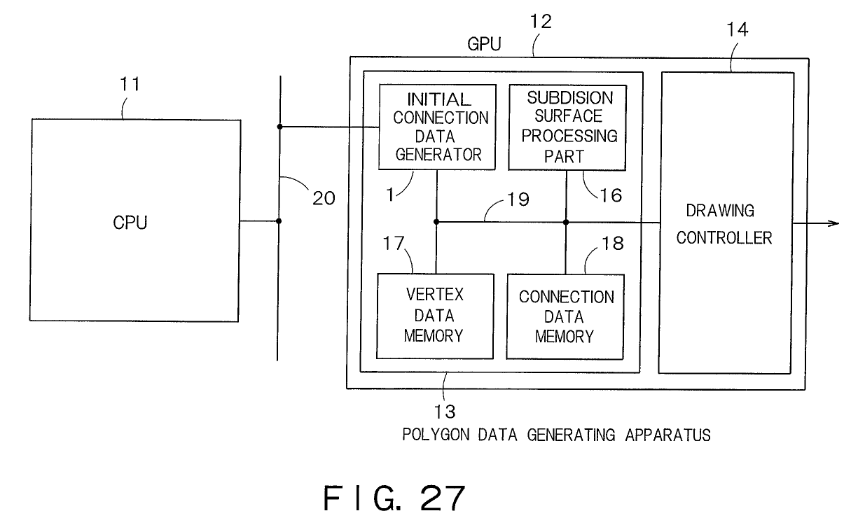

FIG. 27 is a diagram showing an embodiment of a drawing system having the polygon data generating system according to the present embodiment. The drawing system of FIG. 27 has a CPU 11 and a GPU 12. The GPU 12 has a polygon data generating apparatus 13 for performing the same processing operation as that of FIG. 1 and a drawing controller 14.

The polygon data generating apparatus 13 has the initial connection data generator 1, a subdivision surface processor 16, a vertex data memory 17 and a connection data memory 18.

The subdivision surface processor 16 performs the same processing operation as that of the new connection data generator 4 and the new vertex data generator 5 of FIG. 1. The vertex data memory 17 corresponds to the first vertex data storing part 3 and the second vertex data storing part 7 of FIG. 1. The connection data memory 18 corresponds to the first connection data storing part 2 and the second connection data storing part 6 of FIG. 1.

The initial connection data generator 1, the subdivision surface processor 16, the vertex data memory 17, the connection data memory 18 and the drawing controller 14 are connected to internal bus 19. The CPU 11 and the GPU 12 are connected to a common bus 20.

The polygon data generating apparatus 13 of FIG. 27 generates new vertex data and new connection data based on the vertex data of the initial polygon sent from the CPU 11. The drawing system 14 performs the drawing processing based on the vertex data and the connection data generated by the polygon data generating apparatus 13.

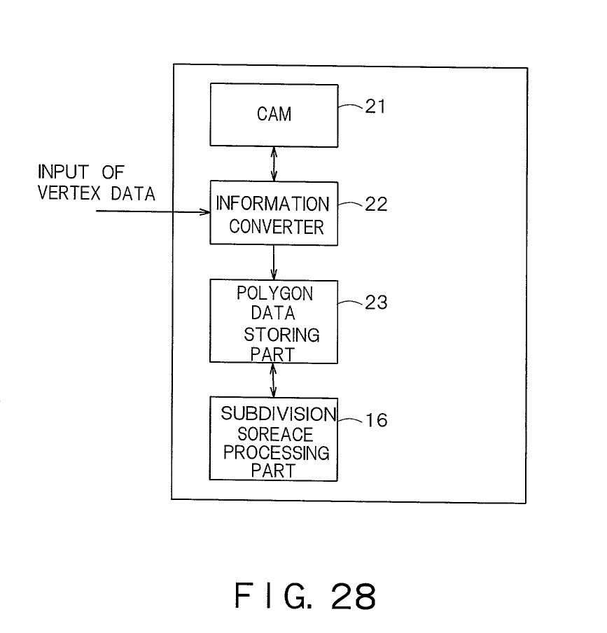

FIG. 28 is a layout diagram of an LSI for integrating the GPU 12 of FIG. 27 as one chip. The LSI of FIG. 28 has a content-addressable memory (CAM) 21, an information converter 22, a polygon data storing part 23 and a subdivision surface processor 16. The lower n bits of the already inputted vertex coordinates are stored in the CAM 21. The CAM 21 compares these n bits data with the lower n bits of the vertex coordinate inputted outside, and determines whether or not the same vertex data exists.

The information converter 22 generates the connection data based on the inputted vertex data, and stores the generated connection data and the inputted vertex data into the polygon data storing part 23, similarly to the initial connection data generator 1 of FIG. 1. The polygon data storing part 23 combines the functions of the vertex data memory 17 and the connection data memory 18 of FIG. 27.

The subdivision surface processor 16 performs the subdivision surface processing to generate the new vertex data and new connection data, similarly to the new connection data generator 4 and the new vertex data generator 5 of FIG. 1, and stores the generated data into the polygon data storing part 23.

The LSI of FIG. 28 searches for the entries of the CAM 21 when the vertex data is inputted from outside. If the same vertex data already exists, the vertex number and the connection data are read out from the polygon data storing part 23. If the same vertex data does not exist, new number is attached to the vertex, and added to the entry of the CAM 21.

Furthermore, the LSI of FIG. 28 stores the vertex data and the connection data of the vertex into the polygon data storing part 23, based on the vertex data inputted from outside. At this time, a new number is always allocated to the face, the previously allocated number is used for the already inputted vertex, and new number is allocated to the newly inputted vertex.

Such a processing is repeatedly performed. If determined that the surrounding of the objective vertex is enclosed by series of polygons, the connection data corresponding to the vertex is deleted from the entry of the CAM 21.

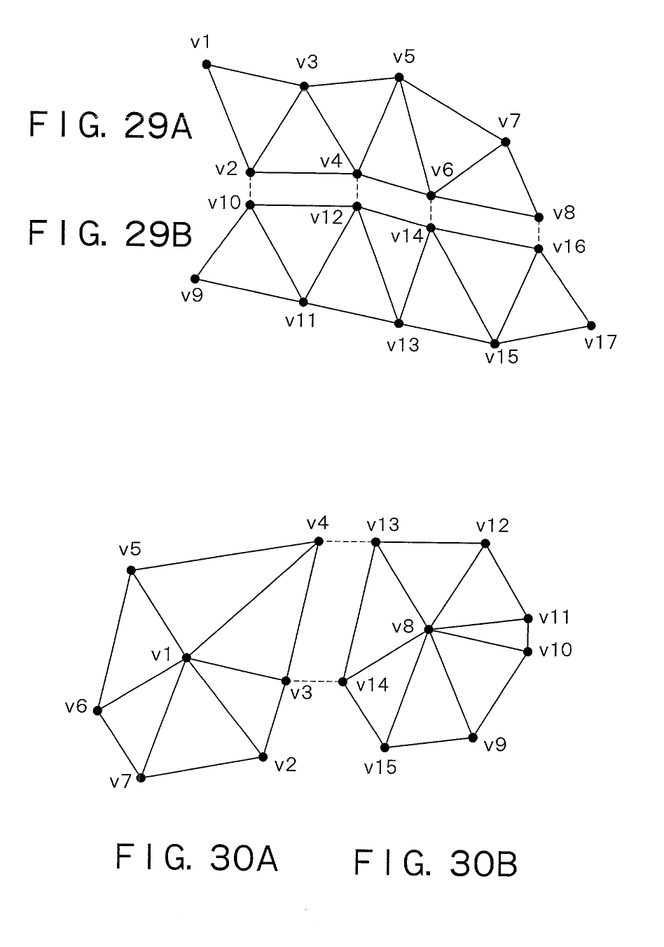

For example, an example in which the vertices of the polygon series shown in FIG. 29A is inputted to the LSI of FIG. 28, and then the vertex data of the polygon series shown in FIG. 29B is inputted will be described hereinafter. The vertices v2, v4, v6 and v8 of FIG. 29A are the same as the vertices v10, v12, v14 and v16 of FIG. 29B.

First of all, the information converter 22 of FIG. 28 allocates the inherent numbers to the sides and the faces generated from the polygon series of FIG. 29A, respectively, and the vertex data and the connection data are generated with regard to the vertices v1-v8. Because these vertices are the vertices inputted firstly, the coordinates of all the vertices are registered in the CAM 21.

Next, when the vertex data of series of polygons shown in FIG. 29B is inputted, because all the vertex data corresponding to the vertices v1, v12, v14 and v16 has already been inputted, the corresponding connection data is read out from the polygon data storing part 23 in order to add the connection information. Because the other vertices are initial vertices, the coordinates of the vertices are registered to the CAM 21.

On the other hand, for example, an example in which the vertex data of a polygon fan shown in FIG. 30A is inputted to the LSI of FIG. 28, and then the vertex data of a polygon fan shown in FIG. 30B is inputted will be described hereinafter. The vertices v3 and v4 of FIG. 30A are the same as the vertices v14 and v13 of FIG. 30B.

The information converter 22 of FIG. 28 allocates the inherent numbers to the sides and the faces generated from the polygon fan of FIG. 30A, respectively, in order to generate the vertex data and the connection data relating to the vertices v1-v7. Because these vertices are inputted firstly, the coordinates of all the vertices are registered to the CAM 21.

Subsequently, when the vertex data of the series of polygon of FIG. 30B is inputted, the connection data corresponding to the vertices v13 and v14 is read out from the polygon data storing part 23 in order to add the connection information. Because the other vertices are inputted firstly, the coordinates of the vertices are registered to the CAM 21.

In FIG. 1, an example in which the connection data is stored by separating into the first connection data storing part 2 and the second connection data storing part 6 has been described. However, these storing parts 2 and 6 are combined into one piece. Similarly, The first vertex data storing part 3 and the second vertex data storing part 7 may be combined into one piece.

The polygon data generating apparatus described in the above-mentioned embodiment, may be realized by hardware or software. If realized by the software, a program for realizing a function of the polygon data generating apparatus is stored in a recording medium such as a floppy disk or a CD-ROM and read out by a computer to execute the program. The recording medium is not limited to a portable medium such as a magnetic disk or an optical disk, and may be a fixed medium such as a hard disk drive or a semiconductor memory.

Furthermore, a program for realizing the function of the polygon data generating apparatus may be distributed through a communication line such as an internet or a radio communication line. Moreover, the program may be distributed through the wired or wireless line such as the internet, or by storing in the recording medium, while encoding, modulating or compressing the program.

What is claimed is:

1. A polygon data generating apparatus, comprising:
an initial connection data generator configured to generate connection data relating to connection information of vertices, sides and faces, based on vertex data of the inputted polygon;
a new connection data generator configured to generate new connection data based on said connection data;
a new vertex data generator configured to generate new vertex data based on said vertex data and said connection data;
a data combining part configured to combine said new connection data relating to the same vertex;
a connection data storing part configured to store the connection data generated by said initial connection data generator and said new connection data generator, and the connection data combined by said data combining part; and
a vertex data storing part configured to store the inputted vertex data and the vertex data generated by said new vertex data generator,
wherein said new connection data generator repeatedly generates said new connection data based on the connection data stored in said connection data storing part; and
said new vertex data storing part repeatedly generates said new vertex data based on the connection data stored in said connection data storing part and the vertex data stored in said vertex data storing part.

2. The polygon data generating apparatus according to claim 1,
wherein said connection data storing part includes:
a first connection data storing part configured to store at least the connection data generated by said initial connection data generator; and
a second connection data storing part configured to store new connection data generated by said new connection data generator,
wherein said data combining part performs the combining processing based on the connection data stored in said second connection data storing part, and stores the combined connection data into said first connection data storing part.

3. The polygon data generating apparatus according to claim 1, further comprising:
a content-addressable memory configured to store vertex coordinates constituting a portion of said vertex data and to determine whether or not the stored vertex coordinates agree with the vertex coordinates included in the inputted vertex data,
wherein said initial connection data generator reads out the connection data relating to the corresponding vertex from said connection data storing part, adds new connection information to the read-out connection data, and stores the added connection data into said connection data storing part when agreement is determined by said content-addressable memory, and generates new connection data relating to the inputted vertex and stores the new connection data into said connection data storing part when disagreement is determined by said content-addressable memory.

4. The polygon data generating apparatus according to claim 1,
wherein said initial connection data generator sets a location to add the connection information in the connection data based on information showing whether each vertex data of the polygon was inputted clockwise or counterclockwise, and information showing whether the vertex data was inputted at an odd number turn or even number turn.

5. The polygon data generating apparatus according to claim 1,
wherein said initial data combining part adds the connection information corresponding to the newly inputted vertex data to a head position or an end position of the connection data of the objective vertex, when the new vertex data is inputted.

6. The polygon data generating apparatus according to claim 1,
wherein said initial connection data generator adds the connection information corresponding to the newly inputted vertex data to the connection data corresponding to the respective vertex data inputted two and one before, when new vertex data is inputted.

7. The polygon data generating apparatus according to claim 6,
wherein said initial connection data generator adds the connection information corresponding to the newly inputted vertex data to a head position of one connection data among the connection data corresponding to the respective vertex data inputted two and one before, and adds the connection information corresponding to the newly inputted vertex data to an end position of the other connection data, when the new vertex is inputted to said initial connection data generator.

8. The polygon data generating apparatus according to claim 1,
wherein said vertex data includes coordinates of the vertices, normal lines of the vertices, and texel coordinates of the vertices; and
said connection data includes the number of the sides including the vertices, the number of the faces including the vertices, an inherent number of the side including the vertices and an inherent number of the other end of the side, an inherent number of the face including the vertices, and an inherent number of the vertex on a diagonal line of the face or an inherent number of a vertex neighbor by sandwiching the other vertex.

9. The polygon data generating apparatus according to claim 1,
wherein said new connection data generator allocates inherent and continuous numbers, which do not overlap to each other, to the inherent numbers of the newly generated vertex, side and face.

10. The polygon data generating apparatus according to claim 9,
The new vertex data generating part allocates 3-fold, 3-fold+1, and 3-fold+2 numbers of the face's number before generating the new vertex, to the newly generated face's number, in the case of a polygon having data structure in which the inputted vertex data is formed by combining triangles.

11. The polygon data generating apparatus according to claim 9,
The new vertex data generating part allocates 4-fold, 4-fold+l, 4-fold+2, and 4-fold+3 numbers of the face's number before generating the new vertex, to the newly generated face's number, in the case of a polygon having data structure in which the inputted vertex data is formed by combining quadrangles.

12. The polygon data generating apparatus according to claim 1,
wherein said new connection data generator stores into said connection data storing part, in sequence of the connection data relating to the vertices before generating the new vertex, the connection data relating to the vertex generated by dividing the sides before generating the new side, and the connection data relating to the vertices generated by dividing the faces before generating the new face.

13. A drawing system, comprising:
an initial vertex data output apparatus configured to output vertex data of an initial polygon;
a polygon data generating apparatus configured to generate new vertex data and connection data of said initial polygon; and
a drawing processing apparatus configured to carry out a drawing processing based on the vertex data and the connection data generated by said polygon data generating apparatus,
wherein said polygon data generating apparatus includes: an initial connection data generator configured to generate connection data relating to connection information of vertices, sides and faces, based on vertex data of the inputted polygon;
a new connection data generator configured to generate new connection data based on said connection data;
a new vertex data generator configured to generate new vertex data based on said vertex data and said connection data;
a data combining part configured to combine said new connection data relating to the same vertex;
a connection data storing part configured to store the connection data generated by said initial connection data generator and said new connection data generator, and the connection data combined by said data combining part; and
a vertex data storing part configured to store the inputted vertex data and the vertex data generated by said new vertex data generator,
wherein said new connection data generator repeatedly generates said new connection data based on the connection data stored in said connection data storing part; and
said new vertex data storing part repeatedly generates said new vertex data based on the connection data stored in said connection data storing part and the vertex data stored in said vertex data storing part.

14. The drawing system according to claim 13, further comprising an arithmetic processing unit configured to perform all the processings of said new connection data generator, said vertex data generator and said data combining part.

15. The polygon data generating apparatus according to claim 13, further comprising:
a content-addressable memory configured to store vertex coordinates constituting a portion of said vertex data and to determine whether or not the stored vertex coordinates agree with the vertex coordinates included in the inputted vertex data,
wherein said initial connection data generator reads out the connection data relating to the corresponding vertex from said connection data storing part, adds new connection information to the read-out connection data, and stores the added connection data into said connection data storing part when agreement is determined by said content-addressable memory, and generates new connection data relating to the inputted vertex and stores the new connection data into said connection data storing part when disagreement is determined by said content-addressable memory.

16. The polygon data generating apparatus according to claim 1,
wherein said initial connection data generator sets a location to add the connection information in the connection data based on information showing which of clockwise or counterclockwise each vertex data of the polygon is inputted, and information showing which of odd number turn or even number turn the vertex is inputted at.

17. The polygon data generating apparatus according to claim 13,
wherein said initial data combining part adds the connection information corresponding to the newly inputted vertex data to a head position or an end position of the connection data of the objective vertex, when the new vertex data is inputted.

18. The polygon data generating apparatus according to claim 13,
wherein said initial connection data generator adds the connection information corresponding to the newly inputted vertex data to the connection data corresponding to the respective vertex data inputted two and one before, when new vertex data is inputted.

19. The polygon data generating apparatus according to claim 13,
wherein said new connection data generator stores into said connection data storing part, in sequence of the connection data relating to the vertices before generating the new vertex, the connection data relating to the vertex generated by dividing the sides before generating the new side, and the connection data relating to the vertices generated by dividing the faces before generating the new face.

20. A method of generating polygon data, comprising
generating first connection data relating to connection information of vertices, sides and faces, based on first vertex data of an inputted polygon;
generating second connection data based on said first connection data;
generating second vertex data based on said first vertex data and said first connection data;
combining said second connection data relating to the same vertex; and
generating repeatedly said second vertex data and said second connection data based on said combined second connection data and said first and second vertex data.
